(19) United States
(12) Patent Application Publication
(10) Pub. No.: US 2001/0045456 A1
(43) Pub. Date: Nov. 29, 2001

(54) Combination fuel dispensing and lottery ticket dispensing method and apparatus

(76) Inventor: Fred Smith, O'Hara Township, PA (US)

Correspondence Address: Russell D. Orkin, 700 Koppers Building, 436 Seventh Avenue, Pittsburgh, PA, 15219-1818, US

(21) Appl. No.: 09/775,083

(22) Filed: Feb. 1, 2001

Related U.S. Application Data
(60) Provisional application No. 60/179,821, filed on Feb. 2, 2000.

(51) Int. Cl. G06F 7/08

(52) U.S. Cl. 235/381

(57) ABSTRACT

A combination fuel dispensing and lottery ticket dispensing system includes a fuel dispensing machine, a computer controller, a display, an input device and a dispensing device. The fuel dispensing machine, the display, the input device and the dispensing device are all in communication with the computer controller. The input device communicates customer-selected lottery ticket information to the computer controller, and the dispensing device dispenses the customer-selected lottery ticket.

### CROSS-REFERENCE TO RELATED APPLICATION

This patent application claims the benefit of U.S. Provisional Application Serial No. 60/179,821 filed Feb. 2, 2000.

### BACKGROUND OF THE INVENTION

1. Field of the Invention

The present invention relates generally to lottery ticket dispensing systems and, in particular, to point-of-sale lottery ticket dispensing systems.

2. Description of the Prior Art

Lottery systems are utilized throughout the United States to aid in supporting governmental activities, decreasing the need for tax increases and providing entertainment to the public. Lottery terminals are placed in publicly accessible locations, such as convenience stores and supermarkets. In this manner, a clerk can dispense lottery tickets directly to consumers. The consumer may pick any number of games to play, and, in the case of number-based games, the consumer must request the numbers verbally to the clerk; the clerk entering the numbers into the machine and outputting the ticket.

In order to effectively enhance the consumer's purchase of lottery tickets, point-of-sale lottery terminals have been suggested. For example, U.S. Pat. No. 5,216,595 to Protheroe describes a point-of-sale lottery dispensing system which allows the simultaneous purchase of other merchandise along with the lottery tickets. This point-of-sale system communicates with an in-store lottery ticket processor, allowing multiple terminals operating at convenient stations throughout a store. Further, U.S. Pat. No. 5,223,698 to Kapur discloses a card-activated point-of-sale lottery system that also provides multiple terminals, all communicating with a central lottery computer. In addition, in order to facilitate the purchase of lottery tickets, U.S. Pat. No. 4,833,307 to Gonzalez-Justiz describes a consumer-operable (or self-serve) lottery ticket dispensing machine.

All of the above-mentioned systems are currently placed at indoor locations (such as supermarket checkout counters) or outdoor locations (such as drive-up self-serve terminals). Unfortunately, all such systems require the consumer to interact with either a clerk or a computer, creating lines during the selection process. As the selection of the game and/or the number is the “enjoyment” of such games-of-chance, hurried selection detracts greatly from this “enjoyment.”

### SUMMARY OF THE INVENTION

It is, therefore, an object of this invention to provide an interactive point-of-sale lottery ticket dispensing terminal at, or integrated with, a gasoline pump. It is another object of this invention to allow interaction with the lottery system while the gasoline is being dispensed into the vehicle. It is a further object of the invention to allow the consumer to use a credit card to pay for both the gasoline and, at the same time, the lottery tickets.

The present invention is a combination fuel dispensing and lottery ticket dispensing system. This combination fuel dispensing and lottery ticket dispensing system includes a fuel dispensing machine, a computer controller, a display in communication with a computer controller, an input device in communication with a computer controller, and a dispensing device in communication with a computer controller. Further, the input device communicates customer-selected lottery ticket information to the computer controller. The dispensing device dispenses the customer-selected lottery ticket.

The present invention also includes a method of dispensing a lottery ticket from a fuel dispensing machine. The fuel dispensing machine has a computer controller, an input device in communication with a computer controller and a dispensing device in communication with a computer controller. The method entails (a) beginning a fuel dispensing operation; (b) during the fuel dispensing operation, inputting customer-selected lottery ticket information via the input device; (c) during the fuel dispensing operation, processing, by the computer controller, the customer-selected lottery ticket information; and (d) dispensing, by the dispensing device, the customer-selected lottery ticket.

The present invention, both as to its construction and its method of operation, together with the additional objects and advantages thereof, will best be understood from the following description of the specific embodiments when read in connection with the accompanying drawings.

### BRIEF DESCRIPTION OF THE DRAWINGS

FIG. 1 is a front view of a combination fuel dispensing and lottery ticket dispensing system according to the present invention;

FIG. 2 is a block diagram illustrating the interrelationship of the components of the combination fuel dispensing and lottery ticket dispensing system of FIG. 1; and

FIG. 3 is a flow diagram showing a method of dispensing a lottery ticket according to the present invention.

### DETAILED DESCRIPTION OF THE PREFERRED EMBODIMENT

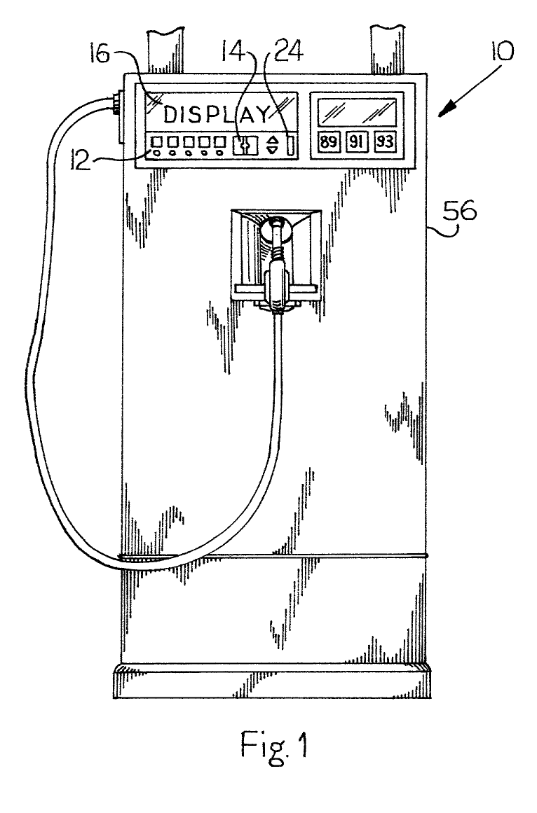

FIG. 1 shows a combination fuel dispensing and lottery ticket dispensing system 10 according to the present invention, which, externally, includes an alphanumeric keypad input 12, a payment input device 14, a dispensing device 24 and a display monitor 16. A consumer, after driving up to a fuel dispensing machine 56 and parking the car, has access to the external components of the system. The combination fuel dispensing and lottery ticket dispensing system 10 is either manufactured together with the fuel dispensing machine 56 or retrofitted into the fuel dispensing machine 56.

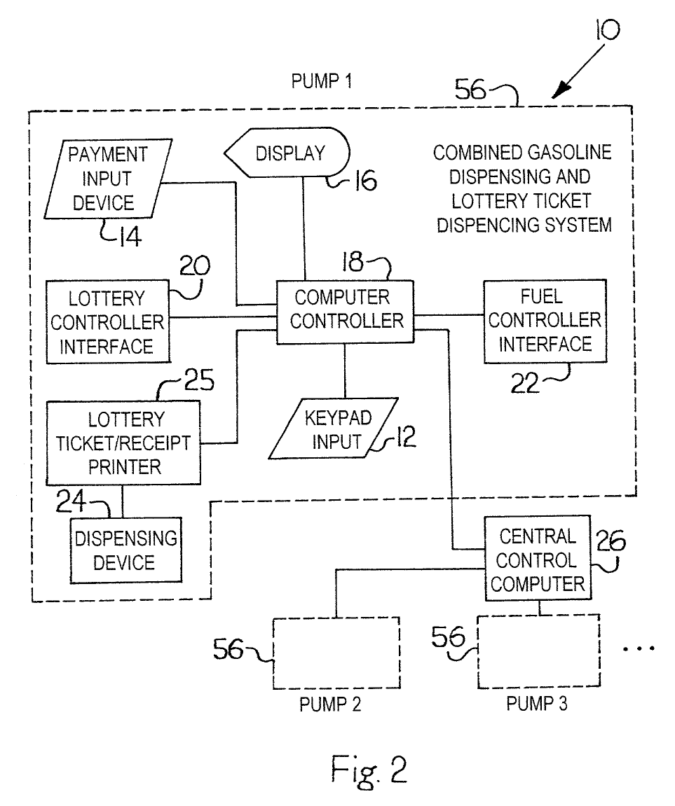

FIG. 2 shows a block diagram illustrating the key features of the present invention, as integrated with the fuel dispensing machine 56 at a service station/convenience store. Each fuel dispensing machine 56 has a stand-alone internal computer controller 18, which may control both a fuel dispensing operation, as well as a lottery ticket selection and dispensing operation. The display 16, the input device 12 and the dispensing device 24 communicate via the computer controller 18. In addition, a lottery controller interface 20 and a fuel controller interface 22 may be provided to facilitate operation of the combination fuel dispensing and lottery ticket dispensing system 10 and/or communication with the computer controller 18.

Using the keypad input 12, the appropriate information is processed by the computer controller 18, which interacts with the fuel controller interface 22 and the lottery controller interface 20. The fuel controller interface 22, using the computer controller 18, controls the fuel dispensing operation, while the lottery controller interface 20, using the computer controller 18, controls the lottery ticket operation. Both the lottery controller interface 20 and the fuel controller interface 22 are manufactured using compatible logic inputs, outputs and processing types. A key feature requires the computer controller 18 to appropriately communicate with each separate component.

The display monitor 16 is the visual control mechanism, allowing the consumer, through menu-driven software, to interact with the combination fuel dispensing and lottery ticket dispensing system 10. Further, the payment input device 14 accepts credit card information and communicates, via the computer controller 18, with other components in the combination fuel dispensing and lottery ticket dispensing system 10. Finally, once all operations are complete, the dispensing device 24 outputs, if necessary, both lottery tickets and fuel receipts.

It is envisioned that the payment input device 14 is adapted to accept credit cards, cash or other forms of payment. Further, the alphanumeric keypad input 12 can be a keyboard, touch screen or any other device allowing information to be transferred to the computer controller 18. The combination fuel dispensing and lottery ticket dispensing system 10 can also include a printing device 25, which is in communication with the computer controller 18. This printing device 25 prints information on an acceptable substrate, e.g., paper or ticket, prior to dispensation through the dispensing device 24. The printing device 25 will print the appropriate customer-selected lottery ticket information on the lottery ticket and/or fuel consumption and payment information in the form of a paper receipt.

As seen in FIG. 2, the combination fuel dispensing and lottery ticket dispensing system 10 communicates with a central control computer 26, via the computer controller 18. The central control computer 26 coordinates and controls each individual combination fuel dispensing and lottery ticket dispensing system 10. In addition, the central control computer 26 is controllable by the clerk or attendant at the service station or convenience store. It is envisioned that the central control computer 26 can coordinate and control incoming and outgoing data from any combination fuel dispensing and lottery ticket dispensing systems 10. The clerk or attendant in the store may monitor the fuel dispensing operation and may observe the customers. Further, the attendant is then able to shut down any combination fuel dispensing and lottery ticket dispensing system 10 that is being used by a customer who appears to be under the age of 18, until they show the appropriate identification.

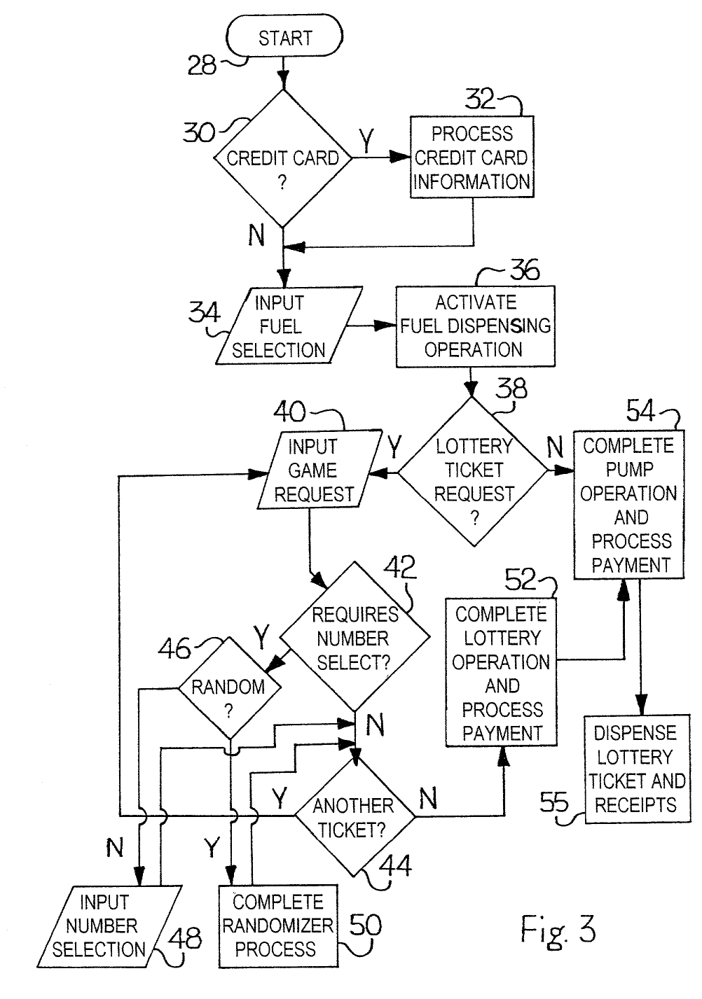

The basic flow of the software system controlling the combination fuel dispensing and lottery ticket dispensing system 10 is illustrated in FIG. 3. Once a consumer pulls up to a fuel dispensing machine 56 and parks the vehicle, the sequence is initiated at the first interaction 28 with the combination fuel dispensing and lottery ticket dispensing system 10. The payment method query step 30 is either initiated by the use of the payment input device 14 or a display monitor 16 which allows the consumer to decide whether or not to pay with credit. If the consumer decides to pay with credit, the combination fuel dispensing and lottery ticket dispensing system 10 moves to the process credit card information step 32, returning “authorized” or “unauthorized” information to the combination fuel dispensing and lottery ticket dispensing system 10.

After the process credit card information step 32, or if the consumer answered “no” to the credit card query step 30, the consumer enters the input fuel selection step 34. This step allows the consumer to choose the specific grade of fuel desired, e.g., 89 octane, 93 octane, etc. After the fuel grade is selected, the fuel dispensing machine 56 is activated in the activate fuel dispensing operation step 36. Step 36 controls the start, stoppage and tracking of fuel flow at the fuel pump 56, feeding information to and from the central control computer 26 via the computer controller 18. Typical fuel control operations are envisioned.

As the consumer is dispensing fuel, the display monitor 16 displays the lottery ticket request query step 38, with a “no” answer proceeding to the complete pump operation and process payment step 54. Step 54 finishes the transaction, and processes the payment information. Finally, in step 55, the receipt is printed and dispensed, and, generally, all necessary requirements to terminate a typical fuel dispensing operation are preformed.

However, if the consumer chooses “yes” to the lottery ticket request query step 38, a list of available lottery games is displayed on the display monitor 16. Concurrently with the display, the customer enters his or her choice at the input game request step 40, using the keypad input 12. Next, the combination fuel dispensing and lottery ticket dispensing system 10 proceeds to the requires number select query step 42. This step, processed without display on the display monitor 16, returns a “yes” or “no” value according to whether the selected lottery game requires the selection of numbers or not. If no number selection is necessary, a “no” is returned and the another ticket step 44 is reached, displaying on the display monitor 16 such a question. If the consumer desires another ticket, the combination fuel dispensing and lottery ticket dispensing system 10 returns to the input game request step 40, and, if the consumer does not wish another ticket, the combination fuel dispensing and lottery ticket dispensing system 10 proceeds to the complete lottery operation step 52.

In the complete lottery operation step 52, the combination fuel dispensing and lottery ticket dispensing system 10 utilizes the lottery controller interface 20 to communicate, via the computer controller 18, with the central control computer 26. The central control computer 26 tracks the lottery game selection and communicates with the lottery ticket/receipt printer 25, which prints the lottery tickets appropriately. After pumping is completed, and assuming the customer has selected to purchase lottery tickets, the combination fuel dispensing and lottery ticket dispensing system 10 proceeds to the complete pump operation step 54. At this point, in step 55, both the lottery ticket(s), as well as a combined fuel and lottery ticket receipt, is dispensed through the dispensing device 24.

Returning to the requires number select query step 42, if the consumer has selected a lottery game that requires the selection of numbers, the combination fuel dispensing and lottery ticket dispensing system 10 moves to the random query step 46. Again displaying a choice to the consumer on the display monitor 16, the consumer may choose to use a random number selector or manually enter specific numbers via the input device 12. If the customer decides to allow the combination fuel dispensing and lottery ticket dispensing system 10 to “pick” numbers, the complete randomizer process step 50 randomly picks and assigns numbers for communication from the lottery controller interface 20, via the computer controller 18, to the central control computer 26. After the complete randomizer process 50 finishes and returns values, combination fuel dispensing and lottery ticket dispensing system 10 moves to the another ticket query step 44, continuing as set forth hereinabove.

If the customer wishes to “pick” his or her own numbers, the combination fuel dispensing and lottery ticket dispensing system 10 enters the input number selection step 48, where the consumer can input, using the keypad input 12, selected values for the lottery tickets. Again, the lottery controller interface 20 communicates with the central control computer 26 using the computer controller 18. The central control computer 26 checks for valid inputs, repeated inputs or transaction canceling commands from the lottery controller interface 20. After verifying and tracking the information, the combination fuel dispensing and lottery ticket dispensing system 10 moves to the another ticket query step 44. As above and as illustrated in FIG. 3, the combination fuel dispensing and lottery ticket dispensing system 10 continues on to the complete lottery operation step 52, to the complete pump operation step 54 and, finally, to the dispensing step 55. The computer control 18 and/or the central control computer 26 may be responsible for controlling the operation and communications of all the components of the combination fuel dispensing and lottery ticket dispensing system 10.

Overall, the combination fuel dispensing and lottery ticket dispensing system 10 can be integrated with a typical fuel dispensing machine 56 system during manufacturing of the system or, if desired, retrofitted, using appropriate integration technology, into a completed fuel dispensing machine 56. The present invention allows the customer to purchase lottery tickets at the fuel pump while the vehicle is receiving fuel, reducing any perceived increase in “wait” time. Also, the present invention eliminates required interaction with the attendant or clerk. When the operation is complete, the combination fuel dispensing and lottery ticket dispensing system 10 completes the lottery operation and the pumping operation, printing both tickets and a receipt at the pump.

This invention has been described with reference to the preferred embodiment, obvious modifications and alterations will occur to others upon reading and understanding the proceeding detailed description. It is intended that the invention be construed as including all such modifications and alterations.

I claim:

1. A combination fuel dispensing and lottery ticket dispensing system, comprising:
a fuel dispensing machine;
a computer controller in communication with the fuel dispensing machine;
a display in communication with the computer controller;
an input device in communication with the computer controller, wherein the input device communicates customer-selected lottery ticket information to the computer controller; and
a dispensing device in communication with the computer controller, wherein the dispensing device dispenses the customer-selected lottery ticket.

2. The combination fuel dispensing and lottery ticket dispensing system of claim 1, wherein the input device comprises a payment input device adapted to communicate payment information through the computer controller.

3. The combination fuel dispensing and lottery ticket dispensing system of claim 2, wherein the payment input device is adapted to receive and communicate credit card information to the computer controller.

4. The combination fuel dispensing and lottery ticket dispensing system of claim 1, further comprising a lottery controller interface in communication with the computer controller, the lottery controller interface controlling operation of the lottery ticket dispensing operation.

5. The combination fuel dispensing and lottery ticket dispensing system of claim 1, wherein the input device comprises an alphanumeric keypad adapted to communicate keypad touches to the computer controller.

6. The combination fuel dispensing and lottery ticket dispensing system of claim 1, wherein the dispensing device dispenses a fuel payment receipt.

7. The combination fuel dispensing and lottery ticket dispensing system of claim 1, further comprising a fuel controller interface in communication with the computer controller, the fuel controller interface controlling operation of the fuel dispensing machine.

8. The combination fuel dispensing and lottery ticket dispensing system of claim 1, further comprising a remote central control computer communicating with the computer controller, the remote central control computer adapted to control the combination fuel dispensing and lottery ticket dispensing system via the computer controller.

9. The combination fuel dispensing and lottery ticket dispensing system of claim 1, further comprising a plurality of fuel dispensing machines.

10. The combination fuel dispensing and lottery ticket dispensing system of claim 1, wherein the display displays fuel selection information.

11. The combination fuel dispensing and lottery ticket dispensing system of claim 1, wherein the display displays the customer-selected lottery ticket information.

12. The combination fuel dispensing and lottery ticket dispensing system of claim 1, further comprising a printing device in communication with a computer controller, the printing device adapted to print information on a substrate prior to dispensation.

13. The combination fuel dispensing and lottery ticket dispensing system of claim 12, wherein the in formation printed on the substrate is one of the lottery ticket information or customer payment information.

14. A method of dispensing a lottery ticket from a fuel dispensing machine having a computer controller, an input device in communication with the computer controller, and a dispensing device in communication with a computer controller, comprising the steps of:
beginning a fuel dispensing operation;
during the fuel dispensing operation, inputting customer-selected lottery ticket information via the input device;
during the fuel dispensing operation, processing, by the computer controller, the customer-selected lottery ticket information; and
dispensing, by the dispensing device, the customer-selected lottery ticket.

15. The method of dispensing a lottery ticket of claim 14, further comprising the steps of:
inputting payment into the input device; and
processing payment information by the computer controller.

16. The method of dispensing a lottery ticket of claim 15, wherein the payment information is credit card information.

17. The method of dispensing a lottery ticket of claim 14, further comprising the step of inputting a customer-requested number selection request via the input device.

18. The method of dispensing a lottery ticket of claim 14, further comprising the steps of:
generating a random number result by the computer controller; and
modifying the lottery ticket information based upon the random number result.

19. The method of dispensing a lottery ticket of claim 14, wherein the input device is an alphanumeric keypad.

20. The method of dispensing a lottery ticket of claim 14, wherein the fuel dispensing machine has a printing device, and further comprising the step of printing the lottery ticket information by the printing device, prior to dispensation.
